(19) United States
(12) Patent Application Publication
(10) Pub. No.: US 2004/0199727 A1
(43) Pub. Date: Oct. 7, 2004

(54) Cache allocation

(76) Inventor: Charles E. Narad, Los Altos, CA (US)

Correspondence Address: FISH & RICHARDSON, PC, 12390 EL CAMINO REAL, SAN DIEGO, CA, 92130-2081, US

(21) Appl. No.: 10/406,798

(22) Filed: Apr. 2, 2003

(51) Int. Cl. G06F 12/08

(52) U.S. Cl. 711/138; 711/137; 711/145

(57) ABSTRACT

Cache allocation includes a cache memory and a cache management mechanism configured to allow an external agent to request data be placed into the cache memory and to allow a processor to cause data to be pulled into the cache memory.

### BACKGROUND

A processor in a computer system may issue a request for data at a requested location in memory. The processor may first attempt to access the data in a memory closely associated with the processor, e.g., a cache, rather than through a typically slower access to main memory. Generally, a cache includes memory that emulates selected regions or blocks of a larger, slower main memory. A cache is typically filled on a demand basis, is physically closer to a processor, and has faster access time than main memory.

If the processor's access to memory “misses” in the cache, e.g., cannot find a copy of the data in the cache, the cache selects a location in the cache to store data that mimics the data at the requested location in main memory, issues a request to the main memory for the data at the requested location, and fills the selected cache location with the data from main memory. The cache may also request and store data located spatially near the requested location as programs that request data often make temporally close requests for data from the same or spatially close memory locations, so it may increase efficiency to include spatially near data in the cache. In this way, the processor may access the data in the cache for this request and/or for subsequent requests for data.

### DESCRIPTION OF DRAWINGS

FIG. 1 is a block diagram of a system including a cache.

FIGS. 2 and 3 are flowcharts showing processes of filling a memory mechanism.

FIG. 4 is a flowchart showing a portion of a process of filling a memory mechanism.

FIG. 5 is a block diagram of a system including a coherent lookaside buffer.

### DESCRIPTION

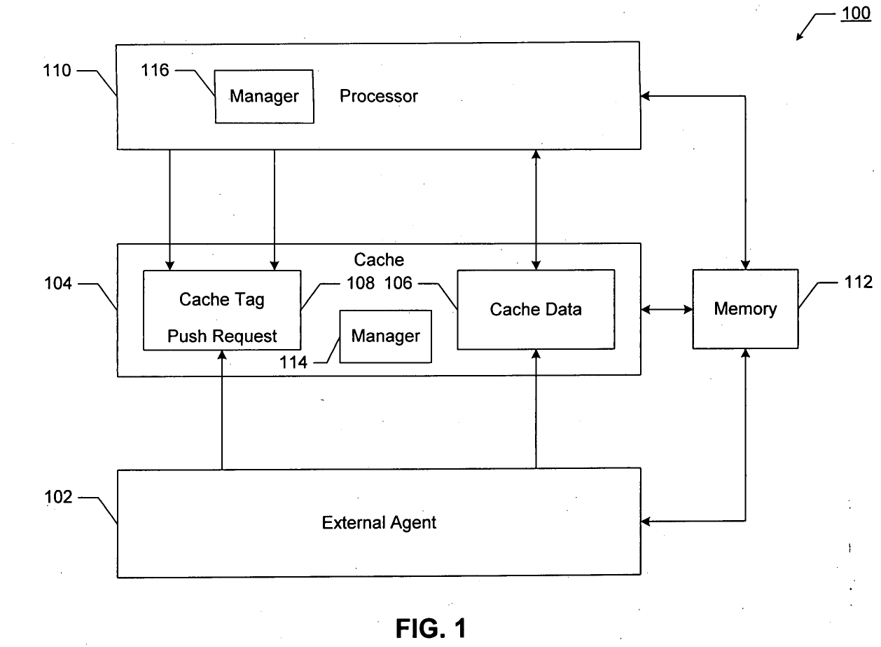

Referring to FIG. 1, an example system 100 includes an external agent 102 that can request allocation of lines of a cache memory 104 (“cache 104”). The external agent 102 may push data into a data memory 106 included in the cache 104 and tags into a tag array 108 included in the cache 104. The external agent 102 may also trigger line allocation and/or coherent updates and/or coherent invalidates in additional local and/or remote caches. Enabling the external agent 102 to trigger allocation of lines of the cache 104 and request delivery of data into the cache 104 can reduce or eliminate penalties associated with a first cache access miss. For example, a processor 110 can share data in a memory 112 with the external agent 102 and one or more other external agents (e.g., input/output (I/O) devices and/or other processors) and incur a cache miss to access data just written by another agent. A cache management mechanism 114 (“manager 114”) allows the external agent 102 to mimic a prefetch of the data on behalf of the processor 110 by triggering space allocation and delivering data into the cache 104 and thereby help reduce cache misses. Cache behavior is typically transparent to the processor 110. A manager such as the manager 114 enables cooperative management of specific cache and memory transfers to enhance performance of memory-based message communication between two agents. The manager 114 can be used to communicate receive descriptors and selected portions of receive buffers to a designated processor from a network interface. The manager 114 can also be used to minimize the cost of inter-processor or inter-thread messages. The processor 110 may also include a manager, for example, a cache management mechanism (manager) 116.

The manager 114 allows the processor 110 to cause a data fill at the cache 104 on demand, where a data fill can include pulling data into, writing data to, or otherwise storing data at the cache 104. For example, when the processor 110 generates a request for data at a location in a main memory 112 (“memory 112”), and the processor's 110 access to the memory location misses in the cache 104, the cache 104, typically using the manager 114, can select a location in the cache 104 to include a copy of the data at the requested location in the memory 112 and issue a request to the memory 112 for the contents of the requested location. The selected location may contain cache data representing a different memory location, which gets displaced, or victimized, by the newly allocated line. In the example of a coherent multiprocessor system, the request to the memory 112 may be satisfied from an agent other than the memory 112, such as a processor cache different from the cache 104.

The manager 114 may also allow the external agent 102 to trigger the cache 104 to victimize current data at a location in the cache 104 selected by the cache 104 by discarding the contents at the selected location or by writing the contents at the selected location back to the memory 112 if the copy of the data in the cache 104 includes updates or modifications not yet reflected in the memory 112. The cache 104 performs victimization and writeback to the memory 112, but the external agent 102 can trigger these events by delivering a request to the cache 104 to store data in the cache 104. For example, the external agent 102 may send a push command including the data to be stored in the cache 104 and address information for the data, avoiding a potential read to the memory 112 before storing the data in the cache 104. If the cache 104 already contains an entry representing the location in memory 106 that is indicated in the push request from the external agent 102, the cache 104 does not allocate a new location nor does it victimize any cache contents. Instead, the cache 104 uses the location with the matching tag, overwrites the corresponding data with the data pushed from the external agent 102 and updates the corresponding cache line state. In a coherent multiprocessor system, caches other than cache 104 having an entry corresponding to the location indicated in the push request will either discard those entries or will update them with the pushed data and new state in order to maintain system cache coherence.

Enabling the external agent 102 to trigger line allocation by the cache 104 while enabling the processor 110 to cause a fill of the cache 104 on a demand basis allows important data, such as critical new data, to selectively be placed temporally closer to the processor 110 in the cache 104 and thus improve processor performance. Line allocation generally refers to performing some or all of selecting a line to victimize in the process of executing a cache fill operation, writing victimized cache contents to a main memory if the contents have been modified, updating tag information to reflect a new main memory address selected by the allocating agent, update cache line state as needed to reflect state information such as that related to writeback or to cache coherence, and replacing the corresponding data block in the cache with the new data issued by the requesting agent.

The data may be delivered from the external agent 102 to the cache 104 as “dirty” or “clean.” If the data is delivered as dirty, the cache 104 updates the memory 112 with the current value of the cache data representing that memory location when the line is eventually victimized from the cache 104. The data may or may not have been modified by the processor 110 after it was pushed into the cache 104. If the data is delivered as clean, then a mechanism other than the cache 104, the external agent 102 in this example, can update the memory 112 with the data. “Dirty”, or some equivalent state, indicates that this cache currently has the most recent copy of the data at that memory location and is responsible for ensuring that the memory 112 is updated when the data is evicted from the cache 104. In a multiprocessor coherent system that responsibility may be transferred to a different cache at that cache's request, for example when another processor attempts to write to that location in the memory 112.

The cache 104 may read and write data to and from the data memory 106. The cache 104 may also access the tag array 108 and produce and modify state information, produce tags, and cause victimization.

The external agent 102 sends new information to the processor 110 via the cache 104 while hiding or reducing access latency for critical portions of the data (e.g., portions accessed first, portions accessed frequently, portions accessed contiguously, etc.). The external agent 102 delivers data closer to a recipient of the data (e.g., at the cache 104) and reduces messaging cost for the recipient. Reducing the amount of time the processor 110 spends stalled due to compelled misses can increase processor performance. If the system 100 includes multiple caches, the manager 114 may allow the processor 110 and/or the external agent 104 to request line allocation in some or all of the caches. Alternatively, only a selected cache or caches receives the push data and other caches take appropriate actions to maintain cache coherence, for example by updating or discarding entries including tags that match the address of the push request.

Before further discussing allocation of cache lines using an external agent, the elements in the system 100 are further described. The elements in the system 100 can be implemented in a variety of ways.

The system 100 may include a network system, computer system, a high integration I/O subsystem on a chip, or other similar type of communication or processing system.

The external agent 102 can include an I/O device, a network interface, a processor, or other mechanism capable of communicating with the cache 104 and the memory 112. I/O devices generally include devices used to transfer data into and/or out of a computer system.

The cache 104 can include a memory mechanism capable of bridging a memory accessor (e.g., the processor 110) and a storage device or main memory (e.g., the memory 112). The cache 104 typically has a faster access time than the main memory. The cache 104 may include a number of levels and may include a dedicated cache, a buffer, a memory bank, or other similar memory mechanism. The cache 104 may include an independent mechanism or be included in a reserved section of main memory. Instructions and data are typically communicated to and from the cache 104 in blocks. A block generally refers to a collection of bits or bytes communicated or processed as a group. A block may include any number of words, and a word may include any number of bits or bytes.

The blocks of data may include data of one or more network communication protocol data units (PDUS) such as Ethernet or Synchronous Optical NETwork (SONET) frames, Transmission Control Protocol (TCP) segments, Internet Protocol (IP) packets, fragments, Asynchronous Transfer Mode (ATM) cells, and so forth, or portions thereof. The blocks of data may further include descriptors. A descriptor is a data structure typically in memory which a sender of a message or packet such as an external agent 102 may use to communicate information about the message or PDU to a recipient such as processor 110. Descriptor contents may include but are not limited to the location(s) of the buffer or buffers containing the message or packet, the number of bytes in the buffer(s), identification of which network port received this packet, error indications etc.

The data memory 106 may include a portion of the cache 104 configured to store data information fetched from main memory (e.g., the memory 112).

The tag array 108 may include a portion of the cache 104 configured to store tag information. The tag information may include an address field indicating which main memory address is represented by the corresponding data entry in the data memory 106 and state information for the corresponding data entry. Generally, state information refers to a code indicating data status such as valid, invalid, dirty (indicating that corresponding data entry has been updated or modified since it was fetched from main memory), exclusive, shared, owned, modified, and other similar states.

The cache 104 includes the manager 114 and may include a single memory mechanism including the data memory 106 and the tag array 108 or the data memory 106 and the tag array 108 may be separate memory mechanisms. If the data memory 106 and the tag array 108 are separate memory mechanisms, then “the cache 104” may be interpreted as the appropriate one or ones of the data memory 106, the tag array 108, and the manager 114.

The manager 114 may include hardware mechanisms which compare requested addresses to tags, detect hits and misses, provide read data to the processor 110, receive write data from the processor 110, manage cache line state, and support coherent operations in response to accesses to memory by agents other than the processor 110. The manager 114 also includes mechanisms for responding to push requests from an external agent 102. The manager 114 can also include any mechanism capable of controlling management of the cache 104, such as software included in or accessible to the processor 110. Such software may provide operations such as cache initialization, cache line invalidation or flushing, explicit allocation of lines and other management functions. The manager 116 may be configured similar to the manager 114.

The processor 110 can include any processing mechanism such as a microprocessor or a central processing unit (CPU). The processor 110 may include one or more individual processors. The processor 110 may include a network processor, a general purpose embedded processor, or other similar type of processor.

The memory 112 can include any storage mechanism. Examples of the memory 112 include random access memory (RAM), dynamic RAM (DRAM), static RAM (SRAM), flash memory, tapes, disks, and other types of similar storage mechanisms. The memory 112 may include one storage mechanism, e.g., one RAM chip, or any combination of storage mechanisms, e.g., multiple RAM chips comprising both SRAM and DRAM.

The system 100 illustrated is simplified for ease of explanation. The system 100 may include more or fewer elements such as one or more storage mechanisms (caches, memories, databases, buffers, etc.), bridges, chipsets, network interfaces, graphics mechanisms, display devices, external agents, communication links (buses, wireless links, etc.), storage controllers, and other similar types of elements that may be included in a system, such as a computer system or a network system, similar to the system 100.

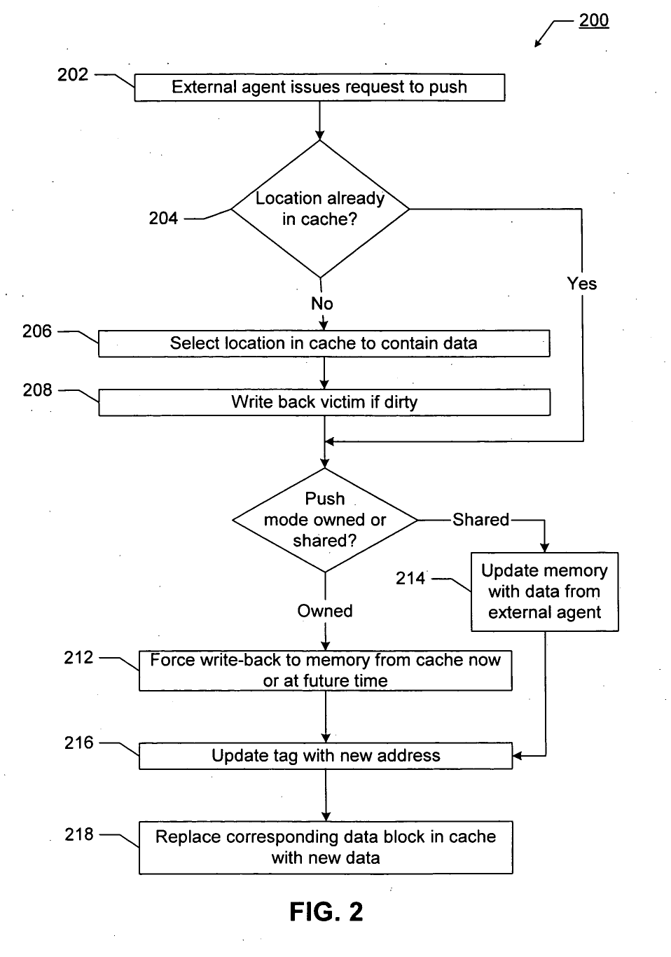

Referring to FIG. 2, an example process 200 of a cache operation is shown. Although the process 200 is described with reference to the elements included in the example system 100 of FIG. 1, this or a similar process, including the same, more, or fewer elements, reorganized or not, may be performed in the system 100 or in another, similar system.

An agent in the system 100 issues 202 a request. The agent, referred to as a requesting agent, may be the external agent 102, the processor 110, or another agent. In this example discussion, the external agent 102 is the requesting agent.

The request for data may include a request for the cache 104 to place data from the requesting agent into the cache 104. The request may be the result of an operation such as a network receive operation, an I/O input, delivery of an inter-processor message, or another similar operation.

The cache 104, typically through the manager 114, determines 204 if the cache 104 includes a location representing the location in the memory 112 indicated in the request. Such a determination may be made by accessing the cache 104 and checking the tag array 108 for the memory address of the data, typically presented by the requesting agent.

If the process 200 is used in a system including multiple caches, perhaps in support of multiple processors or a combination or processors and I/O subsystems, any protocol may be used for checking the multiple caches and maintaining a coherent version of each memory address. The cache 104 may check the state associated with the address of the requested data in a cache's tag array to see if the data at that address is included in another cache and/or if the data at that address has been modified in another cache. For example, an “exclusive” state may indicate that the data at that address is included only in the cache being checked. For another example, a “shared” state may indicate that the data might be included in at least one other cache and that the other caches may need to be checked for more current data before the requesting agent may fetch the requested data. The different processors and/or I/O subsystems may use the same or different techniques for checking and updating cache tags. When data is delivered into a cache at the request of an external agent, the data may be delivered into one or a multiplicity of caches, and those caches to which the data is not explicitly delivered must invalidate or update matching entries in order to maintain system coherence. Which cache or caches to deliver the data to may be indicated in the request, or may be selected statically by other means.

If the tag array 108 includes the address and an indication that the location is valid then a cache hit is recognized. The cache 104 includes an entry representing the location indicated in the request, and the external agent 102 pushes the data to the cache 104, overwriting the old data in the cache line, without needing to first allocate a location in the cache 104. The external agent 102 may push into the cache 104 some or all of the data being communicated to the processor 110 through shared memory. Only some of the data may be pushed into the cache 104, for example, if the requesting agent may not immediately or ever parse all of the data. For example, a network interface might push a receive descriptor and only the leading packet contents such as packet header information. If the external agent 102 is pushing only selected portions of data then typically the other portions which are not pushed are instead written by the external agent 102 into the memory 112. Further, any locations in the cache 104 and in other caches which represent those locations in the memory 112 written by the external agent 102 may be invalidated or updated with the hew data in order to maintain system coherence. Copies of the data in other caches may be invalidated and the cache line in the cache 104 is marked as “exclusive” or the copies are updated and the cache line is marked as “shared.”

If the tag array 108 does not include the requested address in a valid location, then it is a cache miss, and the cache 104 does not include a line representing the requested location in memory 112. In this case the cache 104, typically via actions of the manager 114, selects (“allocates”) a line in the cache 104 in which to place the push data. Allocating a cache line includes selecting a location, determining if that location contains a block that the cache 104 is responsible for writing back to the memory 112, writing the displaced (or “victim”) data to the memory 112 if so, updating the tag of the selected location with the address indicated in the request and with appropriate cache line state, and writing the data from the external agent 102 into the location in the data array 106 corresponding to the selected tag location in the tag array 108.

The cache 104 may respond to the request of the external agent 102 by selecting 206 a location in the cache 104 (e.g., in the data memory 106 and in the tag memory 108) to include a copy of the data. This selection may be called allocation and the selected location may be called an allocated location. If the allocated location contains a valid tag and data representing a different location in the memory 112 then that contents may be called a “victim” and the action of removing it from the cache 104 may be called “victimization.” The state for the victim line may indicate that the cache 104 is responsible for updating 208 the corresponding location in the memory 112 with the data from the victim line when that line gets victimized.

The cache 104 or the external agent 102 may be responsible for updating the memory 112 with the new data pushed to the cache 104 from the external agent 102. When pushing new data into the cache 104, coherence should typically be maintained between memory mechanisms in the system, the cache 104 and the memory 112 in this example system 100. Coherence is maintained by updating any other copies of the modified data residing in other memory mechanisms to reflect the modifications, e.g., by changing its state in the other mechanism(s) to “invalid” or another appropriate state, updating the other mechanism(s) with the modified data, etc. The cache 104 may be marked as the owner of the data and become responsible for updating 212 the memory 112 with the new data. The cache 104 may update the memory 112 when the external agent 102 pushes the data to the cache 104 or at a later time. Alternatively, the data may be shared, and the external agent 102 may update 214 the mechanisms, the memory 112 in this example, and update the memory with the new data pushed into the cache 104. The memory 112 may then include a copy of the most current version of the data.

The cache 104 updates 216 the tag in the tag array 108 for the victimized location with the address in the memory 112 indicated in the request.

The cache 104 may be able to replace 218 the contents at the victimized location with the data from the external agent 102. If the processor 110 supports a cache hierarchy, the external agent 102 may push the data into one or more levels of the cache hierarchy, typically starting with the outermost layer.

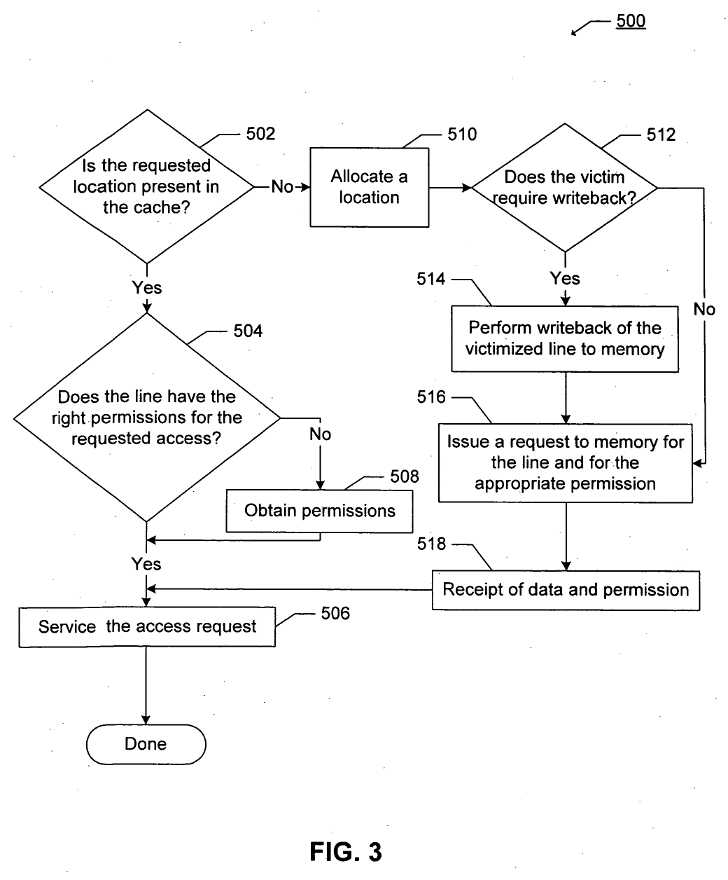

Referring to FIG. 3, another example process 500 of a cache operation is shown. The process 500 describes an example of the processor's 110 access of the cache 104 and demand fill of the cache 104. Although the process 500 is described with reference to the elements included in the example system 100 of FIG. 1, this or a similar process, including the same, more, or fewer elements, reorganized or not, may be performed in the system 100 or in another, similar system.

When the processor 110 issues a cacheable memory reference, the cache(s) 104 associated with that processor's 110 memory accesses will search their associated tag arrays 108 to determine (502) if the requested location is currently represented in those caches. The cache(s) 104 further determine (504) if the referenced entry in the cache(s) 104 have the appropriate permissions for the requested access, for example if the line is in the correct coherent state to allow a write from the processor. If the location in memory 112 is currently represented in the cache 104 and has the right permissions, then a “hit” is detected and the cache services (506) the request by providing data to or accepts data from the processor on behalf of the associated location in memory 112. If the tags in tag array 108 indicate that the requested location is present but does not have the appropriate permissions, the cache manager 114 obtains (508) the right permissions, for example by obtaining exclusive ownership of the line so as to enable writes into it. If the cache 104 determines that the requested location is not in the cache, a “miss” is detected, and the cache manager 114 will allocate (510) a location in the cache 104 in which to place the new line, will request (512) the data from memory 112 with appropriate permissions, and upon receipt (514) of the data will place the data and associated tag into the allocated location in the cache 104. In a system supporting a plurality of caches which maintain coherence among themselves, the requested data may actually have come from another cache rather that from memory 112. Allocation of a line in the cache 104 may victimize current valid contents of that line and may further cause a writeback of the victim as previously described. Thus, process 500 determines (512) if the victim requires a writeback, and if so, performs (514) a writeback of the victimized line to memory.

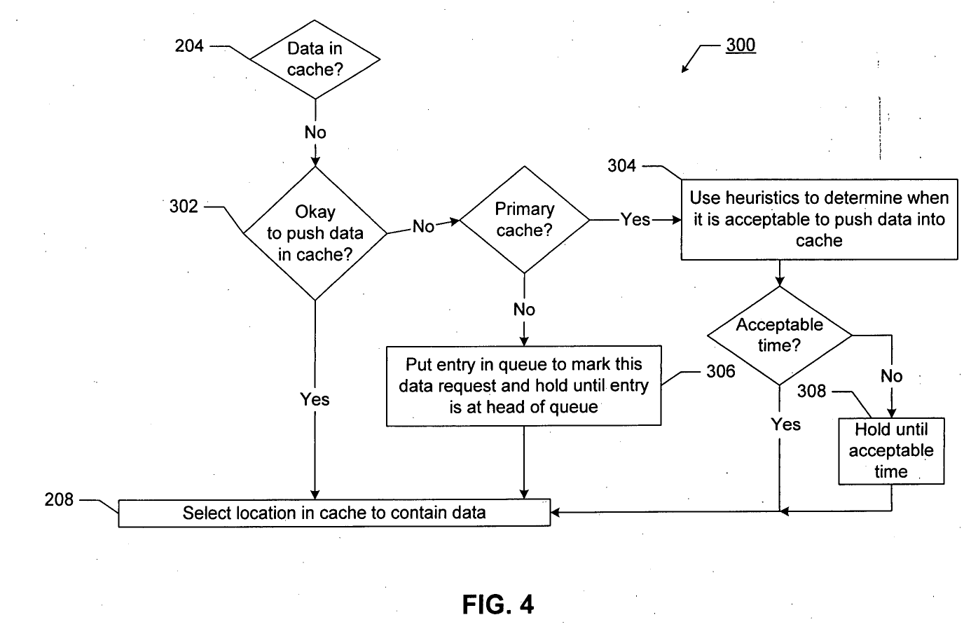

Referring to FIG. 4, a process 300 shows how a throttling mechanism helps to determine 302 if/when the external agent 102 may push data into the cache 104. The throttling mechanism can prevent the external agent 102 from overwhelming the cache 104 and causing too much victimization, which may reduce the system's efficiency. For example, if the external agent 102 pushes data into the cache 104, then that pushed data gets victimized before the processor 110 accesses that location, and the processor 110 later will fault the data back into the cache 104 on demand, thus the processor 110 may incur latency for a cache miss and cause unnecessary cache and memory traffic.

If the cache 104 in which the external agent 102 pushes data is a primary data cache for the processor 110, then the throttling mechanism uses 304 heuristics to determine if/when it is acceptable for the external agent 102 to push more data into the cache 104. If it is an acceptable time, then the cache 104 may select 208 a location in the cache 104 to include the data. If it is not currently an acceptable time, the throttling mechanism may hold 308 the data (or hold its request for the data, or instruct the external agent 102 to retry the request at a later time) until, using heuristics (e.g., based on capacity or based on resource conflicts at the time the request is received), the throttling mechanism determines that it is an acceptable time.

If the cache 104 is a specialized cache, then the throttling mechanism may include a more deterministic mechanism than the heuristics such as threshold detection on a queue that is used 306 to flow-control the external agent 102. Generally, a queue includes a data structure where elements are removed in the same order they were entered.

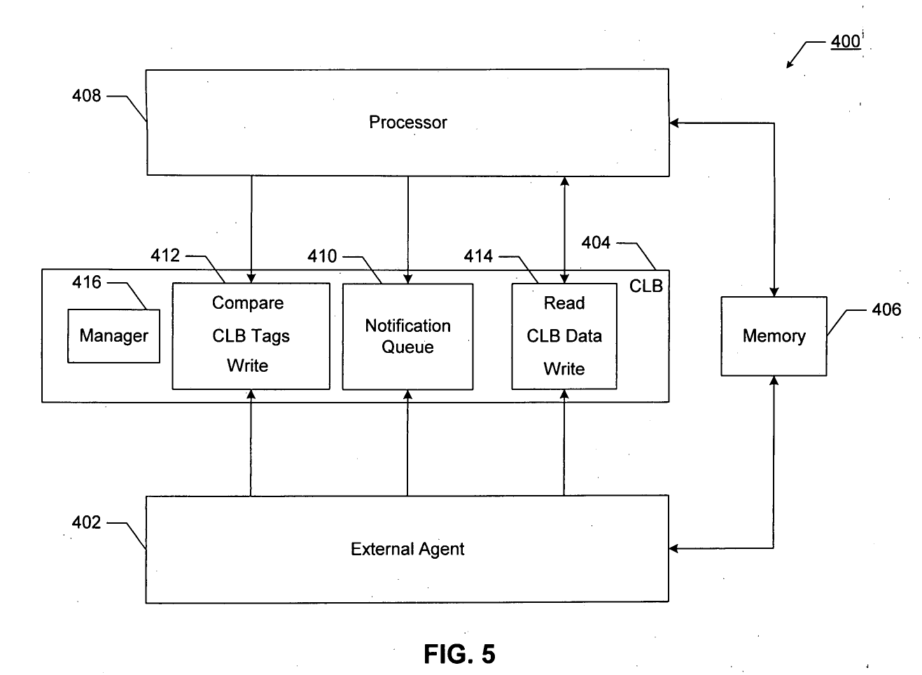

Referring to FIG. 5, another example system 400 includes a manager 416 that may allow an external agent 402 to push data into a coherent lookaside buffer (CLB) cache memory 404 (“CLB 404”) that is a peer of a main memory 406 (“memory 406”) that generally mimics the memory 406. A buffer typically includes a temporary storage area and is accessible with lower latency than main memory, e.g., the memory 406. The CLB 404 provides a staging area for newly-arrived or newly-created data from an external agent 402 which provides a lower-latency access than memory 406 for the processor 408. In a communications mechanism where the processor 408 has known access patterns such as when servicing a ring buffer, use of a CLB 404 can improve the performance of the processor 408 by reducing stalls due to cache misses from accessing new data. The CLB 404 may be shared by multiple agents and/or processors and their corresponding caches.

The CLB 404 is coupled with a signaling or notification queue 410 that the external agent 402 uses to send a descriptor or buffer address to the processor 408 via the CLB 404. The queue 410 provides flow control in that when the queue 410 is full, its corresponding CLB 404 is full. The queue 410 notifies the external agent 102 when the queue 410 is full with a “queue full” indication. Similarly, the queue 410 notifies the processor 408 that the queue has at least one unserviced entry with a “queue not empty” indication, signaling that there is data to handle in the queue 410.

The external agent 402 can push in one or more cache lines worth of data for each entry in the queue 410. The queue 410 includes X entries, where X equals a positive integer number. The CLB 404 uses a pointer to point to the next CLB entry to allocate, treating the queue 410 as a ring.

The CLB 404 includes CLB tags 412 and CLB data 414 (similar to the tag array 108 and data memory 106, respectively, of FIG. 1), and that stores tags and data, respectively. The CLB tags 412 and the CLB data 414 each include Y blocks of data, where Y equals a positive integer number, for each data entry in the queue 410 for a total number of entries equal to X*Y. The tags 412 may contain an indication for each entry of the number of sequential cache blocks represented by the tag, or that information may be implicit. When the processor 408 issues memory reads to fill a cache with lines of data that the external agent 402 pushed into the CLB 404, the CLB 404 may intervene with the pushed data. The CLB may deliver up to Y blocks of data to the processor 408 for each notification. Each block is delivered from the CLB 404 to the processor 408 in response to a cache line fill request whose address matches one of the addresses stored and marked as valid in the CLB tags 412.

The CLB 404 has a read-once policy so that once the processor cache has read a data entry from the CLB data 414, the CLB 404 can invalidate (forget) the entry. If Y is greater than “1” the CLB 404 invalidates each data block individually when that location is accessed, and invalidates the corresponding tag only when all “Y” blocks have been accessed. The processor 408 is required to access all Y blocks associated with a notification.

Elements included in the system 400 may be implemented similar to similarly-named elements included in the system 100 of FIG. 1. The system 400 includes more or fewer elements as described above for the system 100. Furthermore, the system 400 generally operates similar to the examples in FIGS. 2 and 3 except that the external agent 402 pushes data into the CLB 404 instead of the cache 104, and the processor 408 demand-fills the cache from the CLB 404 when the requested data is present in the CLB 404.

The techniques described are not limited to any particular hardware or software configuration; they may find applicability in a wide variety of computing or processing environments. For example, a system for processing network PDUs may include one or more physical layer (PHY) devices (e.g., wire, optic, or wireless PHYs) and one or more link layer devices (e.g., Ethernet media access controllers (MACs) or SONET framers). Receive logic (e.g., receive hardware, processor, or thread) may operate on PDUs received via the PHY and link layer devices by requesting placement of data included in the PDU or a descriptor of the data in a cache operating as described above. Subsequent logic (e.g., a different thread or processor) may quickly access the PDU related data via the cache and perform packet processing operations such as bridging, routing, determining a quality of service (QoS), determining a flow (e.g., based on the source and destination addresses and ports of a PDU), or filtering, among other operations. Such a system may include a network processor (NP) that features a collection of Reduced Instruction Set Computing (RISC) processors. Threads of the NP processors may perform the receive logic and packet processing operations described above.

The techniques may be implemented in hardware, software, or a combination of the two. The techniques may be implemented in programs executing on programmable machines such as mobile computers, stationary computers, networking equipment, personal digital assistants, and similar devices that each include a processor, a storage medium readable by the processor (including volatile and non-volatile memory and/or storage elements), at least one input device, and one or more output devices. Program code is applied to data entered using the input device to perform the functions described and to generate output information. The output information is applied to one or more output devices.

Each program may be implemented in a high level procedural or object oriented programming language to communicate with a machine system. However, the programs can be implemented in assembly or machine language, if desired. In any case, the language may be a compiled or interpreted language.

Each such program may be stored on a storage medium or device, e.g., compact disc read only memory (CD-ROM), hard disk, magnetic diskette, or similar medium or device, that is readable by a general or special purpose programmable machine for configuring and operating the machine when the storage medium or device is read by the computer to perform the procedures described in this document. The system may also be considered to be implemented as a machine-readable storage medium, configured with a program, where the storage medium so configured causes a machine to operate in a specific and predefined manner.

Other embodiments are within the scope of the following claims.

What is claimed is:

1. An apparatus comprising:
a cache memory;
a cache management mechanism configured to allow an external agent to request data be placed into the cache memory and to allow a processor to cause data to be pulled into the cache memory.

2. The apparatus of claim 1 further comprising a throttling mechanism accessible to the cache management mechanism and configured to determine when data may be placed into the cache memory.

3. The apparatus of claim 1 in which the cache management mechanism is also configured to maintain coherence between data included in the cache memory and a copy of the data held at a main memory.

4. The apparatus of claim 3 in which the cache management memory mechanism is also configured to maintain coherence between data included in the cache memory and in one or more other caches.

5. The apparatus of claim 4 in which the cache management mechanism is also configured to invalidate data in the one or more other caches corresponding to data delivered from the external agent to the cache memory.

6. The apparatus of claim 4 in which the cache management mechanism is also configured to update data in the one or more other caches corresponding to the data delivered from the external agent to the cache memory.

7. The apparatus of claim 1 in which the cache management mechanism is also configured to allow the external agent to update a main memory storing a copy of data held in the cache memory.

8. The apparatus of claim 1 in which the cache management mechanism is also configured to allow the external agent to request a line allocation in the cache memory for the data.

9. The apparatus of claim 1 in which the cache management mechanism is also configured to allow the external agent to cause current data included in the cache memory to be overwritten.

10. The apparatus of claim 9 in which the cache management mechanism is also configured to place the data placed in the cache memory into a modified coherence state.

11. The apparatus of claim 10 in which the cache management mechanism is also configured to also place the data placed in the cache memory into an exclusive coherence state.

12. The apparatus of claim 10 in which the cache management mechanism is also configured to also place the data placed in the cache memory into a shared coherence state.

13. The apparatus of claim 9 in which the cache management mechanism is also configured to place the data placed in the cache memory into a clean coherence state.

14. The apparatus of claim 13 in which the cache management mechanism is also configured to also place the data placed in the cache memory into an exclusive coherence state.

15. The apparatus of claim 13 in which the cache management mechanism is also configured to also place the data placed in the cache memory into a shared coherence state.

16. The apparatus of claim 1 further comprising at least one other cache memory that the cache management mechanism is also configured to allow the external agent to request data be placed into.

17. The apparatus of claim 16 in which the cache management mechanism is also configured to allow the external agent to request a line allocation in at least one of the at least one other cache memory for the data to be placed in.

18. The apparatus of claim 16 in which the cache management mechanism is also configured to allow the external agent to request a line allocation in a plurality of the other cache memories for the data to be placed in.

19. The apparatus of claim 16 in which the cache management mechanism is also configure to allow the external agent to cause current data included in the other cache memory or cache memories to be overwitten.

20. The apparatus of claim 1 in which the cache memory includes a cache that mimics a main memory and that other caches may access when trying to access the main memory.

21. The apparatus of claim 20 in which a line included in the cache memory gets deallocated after a read operation by another cache.

22. The apparatus of claim 20 in which a line changes to a shared state after a read operation by another cache.

23. The apparatus of claim 1 in which the external agent includes an input/output device.

24. The apparatus of claim 1 in which the external agent includes a different processor.

25. The apparatus of claim 1 in which the data include data of at least a portion of at least one network communication protocol data unit.

26. A method comprising:
enabling an external agent to issue a request for data to be placed in a cache memory; and
enabling the external agent to provide the data to be placed in the cache memory.

27. The method of claim 26 further comprising enabling a processor to cause data to be pulled into the cache memory.

28. The method of claim 26 further comprising enabling the cache memory to check the cache memory for the data and to request the data from the main memory if the cache memory does not include the data.

29. The method of claim 26 further comprising determining when the external agent may provide data to be placed in the cache memory.

30. The method of claim 26 further comprising enabling the external agent to request the cache memory to select a location for the data in the cache memory.

31. The method of claim 26 further comprising updating the cache memory with an address of the data in a main memory.

32. The method of claim 26 further comprising updating the cache memory with a state of the data.

33. The method of claim 26 further comprising updating, from the external agent, a main memory with the data.

34. An article comprising a machine-accessible medium which stores executable instructions, the instructions causing a machine to:
enable an external agent to issue a request for data to be placed in a cache memory; and
enable the external agent to fill the cache memory with the data.

35. The article of claim 34 further causing a machine to enable a processor to cause data to be pulled into the cache memory.

36. The article of claim 34 further causing a machine to enable the cache memory to check the cache memory for the data and to request the data from the main memory if the cache memory does not include the data.

37. The article of claim 34 further causing a machine to enable the external agent to request the cache memory to select a location for the data in the cache memory.

38. A system comprising:
a cache memory; and
a memory management mechanism configured to allow an external agent to request the cache memory to
select a line of the cache memory as a victim, the line including data, and
replace the data with new data from the external agent.

39. The system of claim 38 in which the memory management mechanism is also configured to allow the external agent to update the cache memory with a location in the main memory of the new data.

40. The system of claim 39 in which the memory management mechanism is also configured to allow an external agent to update a main memory with the new data.

41. The system of claim 39 further comprising:
a processor; and
a cache management mechanism included in the processor and configured to manage the processor's access to the cache memory.

42. The system of claim 39 further comprising at least one additional cache memory, the memory management mechanism also configured to allow the external agent to request some or all of the additional cache memories to allocate a line at their respective additional cache memories.

43. The system of claim 42 in which the memory management mechanism is also configured to update data in the additional cache memory or memories corresponding to the new data from the external agent.

44. The system of claim 39 further comprising a main memory configured to store a master copy of data included in the cache memory.

45. The system of claim 39 further comprising at least one additional external agent, the memory management mechanism configured to allow each of the additional external agents to request the cache memory to
select a line of the cache memory as a victim, the line including data, and
replace the data with new data from the additional external agent that made the request.

46. The system of claim 39 in which the external agent is also configured to push only some of the new data into the cache memory.

47. The system of claim 46 further comprising a network interface configured to push the some of the new data.

48. The system of claim 46 in which the external agent is also configured to write to a main memory portions of the new data not pushed into the cache memory.

49. The system of claim 39 in which data includes descriptors.

50. A system, comprising:
at least one physical layer (PHY) device;
at least one Ethernet media access controller (MAC) device to perform link layer operations on data received via the PHY;
logic to request at least a portion of data received via the at least one PHY and at least one MAC be cached; and
a cache, the cache comprising:
a cache memory;
a cache management mechanism configured to:
place the at least a portion of data received via the at least one PHY and at least one MAC into the cache memory in response to the request; and
allow a processor to cause data to be pulled into the cache memory in response to requests for data not stored in the cache memory.

51. The system of claim 50, wherein the logic comprises at least one thread of a collection of threads provided by a network processor.

52. The system of claim 50, further comprising logic to perform at least one of the following packet processing operations on the data retrieved from the cache: bridging, routing, determining a quality of service, determining a flow, and filtering.
